(19) United States
(12) Patent Application Publication
(10) Pub. No.: US 2002/0189470 A1
(43) Pub. Date: Dec. 19, 2002

(54) Printing group of a rotary printing press

(76) Inventor: Helmut Holm, Erlabrunn (DE)

Correspondence Address: Douglas R Hanscom, Jones Tullar & Cooper, Eads Station, PO Box 2266, Arlington, VA, 22202, US

(21) Appl. No.: 10/111,417

(22) PCT Filed: Dec. 1, 2000
(86) PCT No.: PCT/DE00/04293

(30) Foreign Application Priority Data
Dec. 2, 1999 (DE) 19958133.9
Dec. 2, 1999 (DE) 19958135.5
Apr. 1, 2000 (DE) 10016409.9

(51) Int. Cl. B41F 13/08

(52) U.S. Cl. 101/375; 101/415.1

(57) ABSTRACT

A printing group of a rotary printing press includes at least one form cylinder and at least one transfer cylinder. The form cylinder has at least two printing forme end receiving channels. These two channels are spaced circumferentially. At least one of these form cylinder end receiving channels rolls off against a channel in the transfer cylinder. One of the form cylinder end receiving channels is at least partially covered by a printing form carried by the form cylinder.

The invention relates to a printing group of a rotary printing press in accordance with the preamble of claim 1.

An arrangement of four printing foils one behind the other in the direction of rotation of the forme cylinder, which are maintained in four pits, is known from DE 44 29 210 A1. Each of the printing foils spans a section of an arc of a circle located between two pits.

DE 44 29 891 A1 shows a printing group of a rotary printing press with a double-sized transfer cylinder (i.e. two section lengths over the circumference), which works together with a single-sized forme cylinder.

The arrangement of cylinders of an offset printing group is also known from DE 198 03 809 A1, wherein the circumference of the transfer cylinder is at a ratio of twice that of the forme cylinder. The forme cylinder can be occupied by one printing forme in the circumferential direction, and in its longitudinal direction by at least four vertical print pages in a broadsheet format, or a corresponding number of vertical or horizontal tabloid or book formats. A single slit, which is either continuous in the longitudinal direction, or is divided in the longitudinal direction and offset by 180°, is arranged in the circumferential direction of the transfer cylinder for receiving two blankets, which are arranged next to each other in the longitudinal direction of the cylinder. The blanket is designed, for example, in two layers as a rubber blanket fastened on a support plate.

Recesses in the cylinder surface of the transfer cylinder are proposed in DE 34 41 175 C2 for the purpose of relaxing the rubber blanket. For this purpose it is also possible to arrange a backing between the cylinder and the rubber blanket, which does not extend in the circumferential direction over the entire length of the rubber blanket and has a gap. An insertion slit for receiving the discontinuous backing is arranged on the circumference of the cylinder next to the bracing groove for the rubber blanket. The recesses arranged in the longitudinal direction of the transfer cylinder, and the groove receiving the rubber blanket are arranged in such a way that in the contact area they respectively work together with the groove of the plate cylinder.

DE 197 40 575 A1 shows forme and transfer cylinders, which work together, wherein the transfer cylinders in one exemplary embodiment have two bracing grooves located one behind the other and two rubber blankets maintained in the bracing grooves. In another example, a double-sized transfer cylinder acts together with a double-sized forme cylinder wherein, however, both cylinders have only one bracing groove in the circumferential direction. In all examples the grooves do not roll off on each other.

A single forme cylinder is known from DE-OS 19 60 635, which, in the circumferential direction, has several grooves for fastening printing formes on its circumference. At least one of the grooves can be covered when placing a printing forme on the forme cylinder in the circumferential direction.

The object of the invention is based on providing a printing group of a rotary printing press.

In accordance with the invention, this object is attained by the characteristics of claim 1.

The advantages to be obtained by means of the invention lie in particular in that a flexible employment of several dressing formats is possible and in that, when using dressings of great unwinding lengths, a pressure relief in the areas of grooves, in particular in the area of grooves covered by dressings, is assured at the same time, as well as the highest possible print quality in the course of unwinding the printed image.

The arrangement of several grooves, each extending in the longitudinal direction of the forme and/or transfer cylinder, meets the most diverse conditions as required, without it being necessary to exchange the cylinder in case of varying demands made on existing printing presses, or to consider every demanded profile individually during the manufacturing process.

It is particularly advantageous that it is possible to take into consideration different formats of the dressings in the circumferential and longitudinal direction, as well as different groupings and phase shifts of the cylinders which work together in a reciprocal manner, which in this way can be optimized in respect to the demands, some of which are in conflict with each other, regarding maintaining the registration, low vibration, arrangement of the printing areas rolling off on each other, and minimizing paper which cannot be imprinted.

An advantageous embodiment of a forme cylinder with double circumference, i.e. for example two newspaper pages in the circumferential direction, allows the selective placement of printing formes arranged one behind the other in the circumferential direction, or of printing formes extending over the entire circumference, in which case a groove is covered. The arrangement of printing formes extending over the full circumference considerably reduces the change-over time, for example. In case of a transfer cylinder, an arrangement of blankets extending over the full circumference considerably reduces the change-over time.

By means of arranging at least two grooves, which are almost continuous in the longitudinal direction, on a transfer cylinder, a multitude of options for arranging dressings, for example blankets, is created. With the arrangement of several grooves it is also advantageous in view of the quality of the unwinding of the printed image in comparison with cylinders of twice the size, but with only one groove, that a covered groove can simultaneously be used for relaxing the dressing in the case of blankets extending over the entire circumference.

The arrangement of a single dressing extending in the longitudinal and circumferential direction results in advantages regarding the multitude of printable formats (height and width of the printed areas, for example panorama).

When covering a groove by means of a printing forme, it is advantageous for reasons of the danger of a break to arrange the forme cylinder and transfer cylinder in such a way that the covered groove rolls off on a groove of the transfer cylinder. The roll-off of a groove of the transfer cylinder covered by a blanket on a groove of the forme cylinder is also advantageous in view of a further improved relaxation of the blanket in the course of the passage of the grooves over each other, and therefore for the rolled-off printed image.

The arrangement of several dressings, which are arranged next to each other in the longitudinal direction of the cylinder, each of which extends almost over the entire circumference, has advantages, for example in view of their handling and individual replacement capability. This applies in particular for long cylinders, such as is the case for double-width (for example four newspaper pages in the longitudinal direction of the cylinder) or even triple-width (for example six newspaper pages) cylinders.

Regarding the quality of unwinding of the printed image, the embodiment of the dressings for the transfer cylinder is also advantageous in the form of multi-layered or multi-ply blanket, which has a support plate and a cover, or layer, connected with the latter. With large dimensions in particular, an embodiment which is dimensionally stable as much as possible is essential for a consistently good and exactly registered printing quality over the circumference of the cylinder.

An embodiment of the grooves with a narrow opening toward the shell surface of the cylinder is also advantageous, for example in view of reducing the paper consumption. A narrow opening is particularly advantageous for grooves in the forme cylinder, in particular for grooves which are at least partially covered. For example, it is possible by means of this to further reduce the breaking danger.

It is moreover advantageous to make the circumferential ratio of the transfer cylinder in respect to the forme cylinder as a whole number and to arrange the grooves symmetrically in the circumferential direction on the cylinder.

Exemplary embodiments of the invention are represented in the drawings and will be described in greater detail in what follows.

Shown are in:

FIG. 1, a pair of double-width cylinders, wherein the forme cylinder is designed with two grooves extending in the longitudinal direction, and the dressings extend over almost the complete circumference of the forme cylinder,

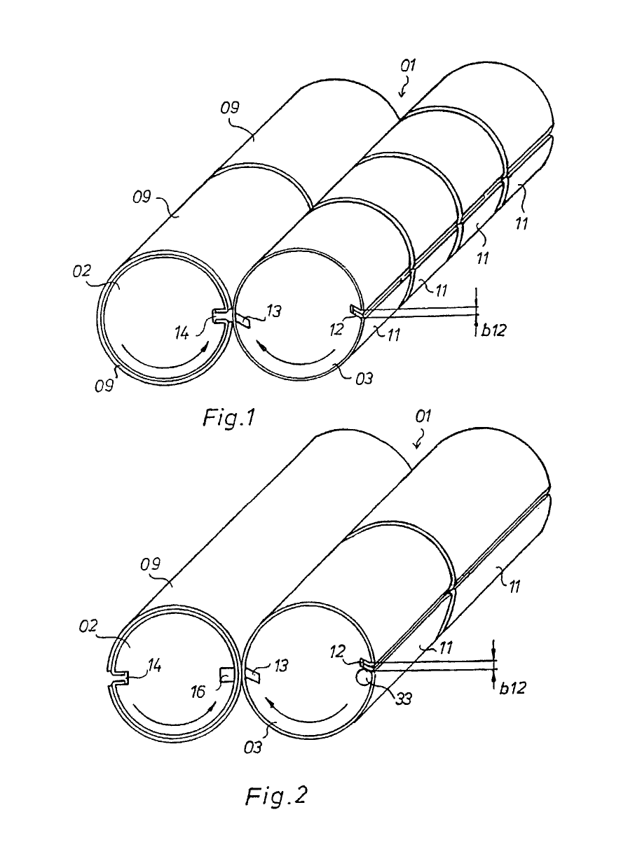

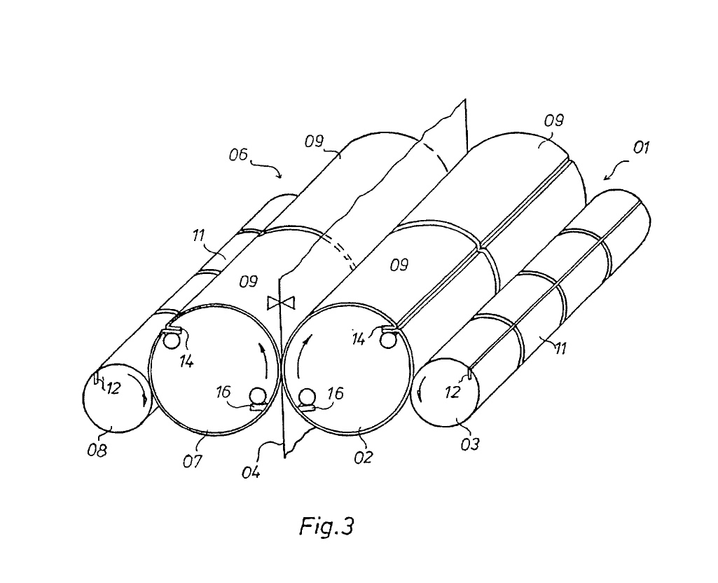

FIG. 2, a pair of double-width cylinders, wherein the forme and the transfer cylinders are each designed with two grooves extending in the longitudinal direction, and the dressings extend over almost the complete circumference of the forme and transfer cylinder,

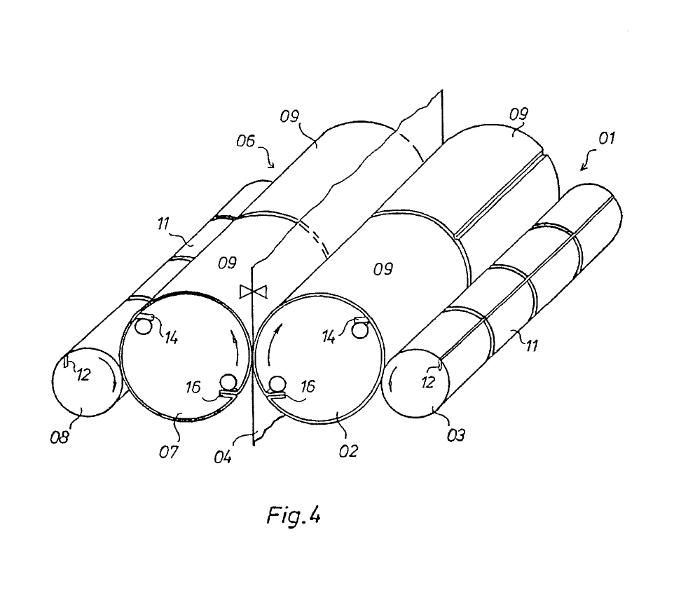

FIG. 3, two pairs of double-width cylinders, wherein the transfer cylinder is designed with two grooves extending in the longitudinal direction and is equipped with two dressings extending over almost the entire circumference, which are located next to each other in the longitudinal direction,

FIG. 4, two pairs of double-width cylinders, wherein the transfer cylinder is designed with two grooves extending in the longitudinal direction and is equipped with two dressings extending over almost the entire circumference, which are located next to each other in the longitudinal direction, but are offset by 180° in the circumferential direction,

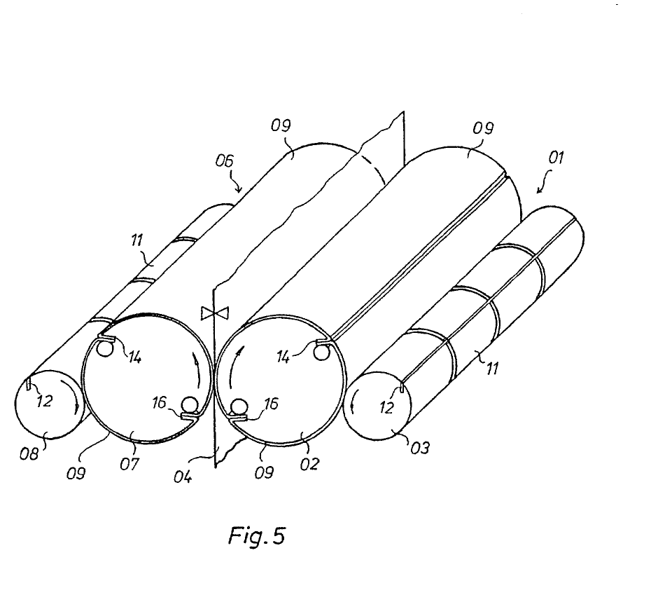

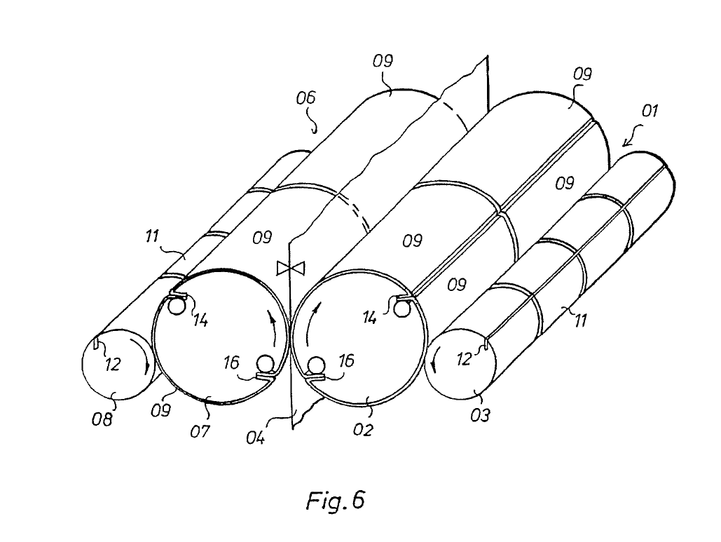

FIG. 5, two pairs of double-width cylinders, wherein the transfer cylinder is designed with two grooves extending in the longitudinal direction and is equipped with two dressings extending over almost the entire length of the barrel, which are located one behind the other in the circumferential direction,

FIG. 6, two pairs of double-width cylinders, wherein the transfer cylinder is designed with two grooves extending in the longitudinal direction and has four dressings, wherein respectively two dressings arranged one behind the other in the circumferential direction are arranged next to each other in the longitudinal direction,

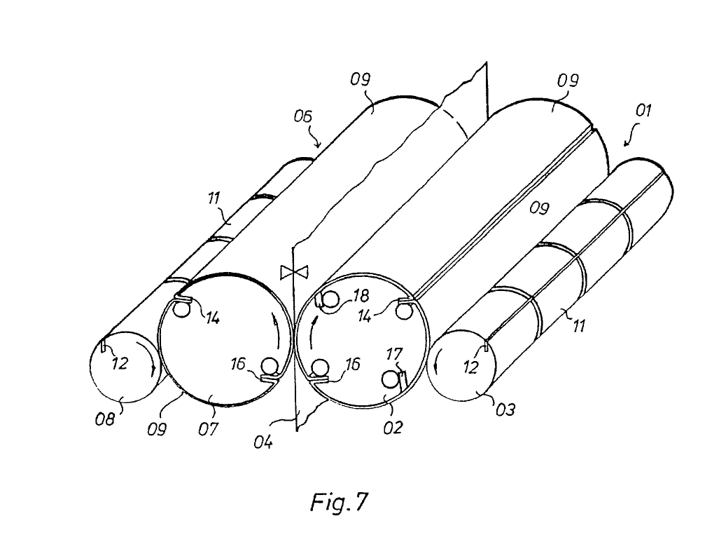

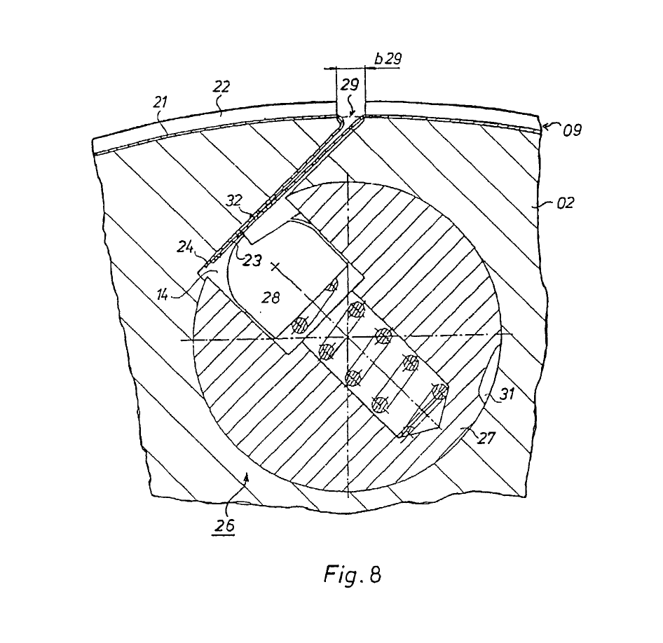

FIG. 7, two pairs of double-width cylinders, wherein the transfer cylinder is designed with four grooves, each extending in the longitudinal direction, and is equipped with two dressings extending over almost the entire length of the barrel, which are located one behind the other in the circumferential direction,

FIG. 8, a multi-layer blanket with a groove and holding device.

A printing group of a rotary printing press has at least one cylinder pair 01, consisting of two cylinder 02, 03, for example a transfer cylinder 02 and a forme cylinder 03 acting together with it. Via the material 04 to be imprinted, the transfer cylinder 02 can act together with a counter-pressure cylinder, not represented, or with a transfer cylinder 07, to which a forme cylinder 08 is assigned, of a second cylinder pair 06. The transfer cylinder 02, 07 can each be equipped with at least one dressing 09, for example a blanket 09, and the forme cylinders 03, 08 each with at least one dressing 11, for example a printing forme 11.

Depending on the demands made on the printing formats and the printing output, as well as possibilities regarding the paper guidance, the cylinder pairs 01, 06 are embodied to be of various width. For example, the cylinder pairs 01, 06 for printing newspapers are designed to be of single, double or triple width, wherein single width identifies the width of the barrel, for example that of the forme cylinder 03, for two vertical or horizontal newspaper pages. In connection with job printing, double width identifies the width required for four horizontal or six vertical A4 pages. The circumferences of the transfer cylinders 02, 07 and of the forme cylinders 03, 08, are respectively of single or double width in relation to the most varied vertical or horizontal formats, for example a vertical or a horizontal newspaper format. Advantageous groupings in connection with newspaper printing are, for example, a double-width circumference, i.e. two pages in the circumferential direction, of the transfer cylinder 02, 07, acting together with a double or single circumference of the forme cylinder 03, 08, each of double width.

FIG. 1 shows a double-width cylinder pair 01, wherein the transfer cylinder 02 and the forme cylinder 03 each have a double circumference. The forme cylinder 03 has two grooves 12, 13, extending in the longitudinal direction and spaced apart in the circumferential direction, for receiving the ends of at least one printing forme 11, the transfer cylinder 02 has a groove 14 for receiving the ends of at least one blanket 09. The grooves 12, 13 of the forme cylinder 03, 08 are arranged, at least over a partial section in the longitudinal direction of the forme cylinder 03, 08, behind each other in the circumferential direction, viewed in a cross section extending perpendicular in respect to the axis of rotation. In the example, the forme cylinder 03 is equipped with four printing formes 11, for example printing plates 11, arranged next to each other in the longitudinal direction of the cylinder, whose respective two ends are maintained in the groove 12, each one extending over the entire circumference, except for the area of the groove 12, and each covering over the groove 13. To prevent the danger of breaking, in an advantageous manner the forme cylinder 03 and the transfer cylinder 02 are arranged in respect to each other in such a way that, in the course of rolling off, the covered groove 13 acts together with the groove 14 of the transfer cylinder 02. The latter is not necessary if, for example, the groove 13 can be closed off by means of a releasable cover, or the groove width is so small that a break is avoided. The forme cylinder 03 can be embodied to be of single, double or triple width. It can be flexibly covered in various ways, for example with one continuous or two or more printing plates 11 of the most varied formats (for example single, panorama), arranged next to each other in the longitudinal direction. If needed, the forme cylinder 03 can also have more than two grooves 12, 13, which extend in the longitudinal direction and are spaced apart in the circumferential direction. The transfer cylinder 02 in FIG. 1 can have a continuous groove 14, in which two blankets 09 are held next to each other in the axial direction. However, it is also possible to arrange two grooves 14, 16, which are next to each other in the axial direction, but offset in respect to each other, for example by 180°, wherein the blankets arranged next to each other are also offset in respect to each other (not explicitly represented, the second groove 16 would be covered in FIG. 1 and would not be visible).

The transfer cylinder 02 can also have a second groove 16 which, for example, lies diametrically opposite and extends in the longitudinal direction of the transfer cylinder 02, as represented by way of example in FIG. 2. The grooves 14, 16 of the transfer cylinder 02, 07 are arranged, at least over a partial section in the longitudinal direction of the transfer cylinder 03, 08, behind each other in the circumferential direction, viewed in a cross section extending perpendicular in respect to the axis of rotation. In the example, a single blanket 09, which extends as far as the area of the groove 14 over the entire length of the barrel and over almost the entire circumference, covers the transfer cylinder 02. By way of example, the forme cylinder is here covered by two printing plates 11, which lie next to each other in the longitudinal direction of the cylinder and each of which extends over almost the entire circumference. In the example, the covered groove 13 acts together with the also covered groove 16 of the transfer cylinder 02. But as in the first exemplary embodiment, it can also roll off on the uncovered groove 14.

Besides the double-width embodiment represented in FIGS. 1 and 2 of the transfer cylinder 03, 08, which acts together with the forme cylinder 03, 08, it can also be embodied at a single or triple width, for example. The transfer cylinder 02, 07 in the first two exemplary embodiments (FIGS. 1, 2), which acts together with the forme cylinder 03, 08 having two grooves 12, 13, can, as shown in FIGS. 1 to 7 and their description by way of example, be equipped flexibly with one continuous, with two or more blankets 09, arranged next to each other in the longitudinal direction, or behind each other in the circumferential direction, or with several blankets 09, arranged next to each other in the longitudinal direction and simultaneously with several arranged behind each other in the circumferential direction. In this case a forme cylinder 03 of double width, for example, from FIGS. 1 and 2 and their description, can take the place of the forme cylinders 03, 08 represented in FIGS. 3 to 7. If required, the transfer cylinder 03 can also have more than two grooves 12, 13 extending in the longitudinal direction and spaced apart in the circumferential direction. A conventionally constructed and equipped transfer cylinder (for example of double size, only one groove, one or two blankets next to each other in the longitudinal direction), or a transfer cylinder of twice the circumference, having two grooves arranged next to each other offset in the axial direction and simultaneously behind each other in the circumferential direction, and which can be covered with two blankets, for example offset in respect to each other in the circumferential and longitudinal direction, can act together with the embodiments of the forme cylinder 03, 08 represented in accordance with FIGS. 1 and 2.

However, it is advantageous for all embodiments of the transfer cylinder 02, 07 acting together with the forme cylinder 03, 08, if the former has at least one groove 14, 16 in the longitudinal direction, and if the at least partially covered groove 12, 13 of the forme cylinder 03, 08 rolls off on this groove 14, 16.

Some further advantageous exemplary embodiments for the arrangement of blankets 09 on a transfer cylinder 02, 07 are represented in the subsequent exemplary embodiments, FIGS. 3 to 7, and the associated description, wherein the transfer cylinder 02, 07 has several grooves 14, 16 extending in the longitudinal direction. The examples respectively show two double-width cylinder pairs 01, 06 constituting a printing unit, wherein the two transfer cylinders 02, 07 act together via the material to be printed. However, if required, the cylinder pairs 01, 06 can also be embodied to be of single, triple or even quadruple width. In this case the teaching from the examples must be applied accordingly. In the examples, the transfer cylinder 02, 07 has a circumference twice the size of that of the forme cylinder 03, 08, which in this case is covered with four printing plates, respectively arranged next to each other in the longitudinal direction. However, in the same way the forme cylinder 03, 08 can also be covered with two panorama printing formes arranged next to each other, or with one panorama printing forme and two single printing formes. However, in connection with all following exemplary embodiments the cooperating forme cylinder 03, 08 can also be designed to be twice the size, it can be equipped with one or two grooves 12, 13, with two printing formes 11 arranged next to each other in the axial direction or behind each other in the circumferential direction, or with several printing formes arranged next to each other in the longitudinal direction and simultaneously with several arranged behind each other in the circumferential direction. The embodiments of the forme cylinder 03, 08 represented in FIGS, 1 and 2, acting together with the transfer cylinders 02, 07 of FIGS. 3 to 7 can also be employed.

However, it is advantageous for all embodiment variations of the forme cylinder 03, 08 acting together with the transfer cylinder 02, 07 from the exemplary embodiments 2 to 4 and 7, if it has at least one groove 12, 13 in the longitudinal direction and the at least partially covered groove 14, 16 of the transfer cylinder 02, 07 rolls off on it.

FIG. 3 shows the arrangement of two blankets 09 on a transfer cylinder 02, 07, which are arranged next to each other in the longitudinal direction of the latter, each extending over almost the full circumference. Two grooves 14, 16 extend in the longitudinal direction of the transfer cylinder 02, 07 and are arranged offset by almost 180° in the circumferential direction. The groove 16 is covered and can counteract flexing, in particular in connection with blankets 09 which are not dimensionally stable, and as a relief unit it can relax the dressing. In an advantageous manner the groove 14, or the covered groove 16, acts together with the groove 12 of the forme cylinder 03, 08 when the cylinders roll off on each other. In accordance with FIG. 4, the two blankets 09 can also be arranged offset by 180° in the circumferential direction in respect to each other, in which case then a portion of the groove 14 and a portion of the groove 16 are respectively covered. In particular in connection with very long cylinders, the arrangement of three or more blankets 09 placed next to each other takes place in an analogous manner either aligned or alternatingly.

The arrangement of two blankets 09, which are arranged one behind the other in the circumferential direction and each of which extends over almost the entire length of the barrel, on a transfer cylinder 02, 07, which in respect to a newspaper page is of double width and has a doubled circumference, is represented in FIG. 5. Four newspaper pages, arranged next to each other in the longitudinal direction of the transfer cylinder 02, 07, are transferred per blanket 09. If more than two grooves 14, 16 are arranged on the transfer cylinder 02, 07, the arrangement of a corresponding number of blankets 09, or the covering of the grooves 14, 16, is possible.

FIG. 6 shows the arrangement of four blankets 09 on a transfer cylinder 02, 07 which is, for example, of double width and double size. Respectively two blankets 09, arranged behind each other in the longitudinal direction, are arranged next to each other in the circumferential direction. More than respectively two blankets are to be arranged in the longitudinal, or circumferential direction in an analogous manner, in particular for longer or thicker cylinders. However, the latter requires a corresponding number of grooves 14, 16.

FIG. 7 shows a covering of the transfer cylinder 02, 07, for example with four grooves 14, 16, 17, 18, with two dressings 09, 11 arranged behind each other in the circumferential direction, wherein in this case every second groove 17, 18 is covered. This applies analogously to the arrangement of four grooves on forme cylinders 03, 08.

A respectively symmetrical arrangement of the grooves 12, 13, or 14, 16 in the circumferential direction at almost identical intermediate angles is advantageous for the transfer cylinder 02, 07, as well as for the forme cylinders 03, 08, for example with two grooves 12, 13, or 14, 16, offset by respectively 180°, with three by respectively 120°, or alternatingly offset by 180°. With more than respectively two grooves 12, 13, or 14, 16, several printing plates 11 or blankets 09 arranged next to each other in the longitudinal direction can also be offset in respect to each other in the circumferential direction.

The ratio of the circumference of the transfer cylinders 02, 07 to that of the forme cylinders 03, 08 is advantageously a whole number, in particular in case of a forme cylinder 03, 08 with grooves 12, 13 arranged behind each other in the circumferential direction equal to 1 with a double-size circumference.

The two cylinder pairs 01 and 06 represented in FIGS. 3 to 7 do not have to be equipped in the same way with the same number of grooves or the same groove geometry, or covered in the same pattern of the dressings 09, 11. However, a matching of the phases of the non-printing areas of the transfer cylinders 02, 07 acting together is advantageous, so that non-printing areas, in particular areas of the covered or not covered grooves, act together if possible. The forme cylinders 03 and the transfer cylinders 02 described in FIGS. 1 to 7 can of course also be covered in the “conventional” way, i.e. with several dressings 09, 11, whose number is determined by the number of grooves, and which are arranged one behind the other in the circumferential direction.

The coverings of the transfer cylinder 02, 07 with blankets 09, represented in FIGS. 1 to 7 and in the associated descriptions, should also be used correspondingly for the respectively other exemplary embodiments. The same applies to the covering of the forme cylinders 03, 08 and the transfer to the other exemplary embodiments in connection with the various embodiments of the transfer cylinder 02, 07.

In FIGS. 1 to 7 the grooves 12, 13, 14, 16, 17, 18 are each represented as extending to the front face of the cylinder 02, 04, 07, 08. However, for reasons of stability, for reasons of soiling, or when using bearer rings, for example, there can be an edge at the front face without a groove 12, 13, 14, 16, 17, 18. In this case the grooves 12, 13, 14, 16, 17, 18 extend over almost the entire length of the cylinder 02, 03, 07, 08, or of its barrel.

The embodiments and exemplary embodiments mentioned for the arrangement of the grooves 12, 13, 14, 16, 17, 18 and dressings 09, 11 on transfer cylinders 02, 07 and forme cylinders 03, 08, as well as configurations of print units with a cylinder pair 01, 06 consisting of a transfer cylinder 02, 07 and a forme cylinder 01, 06 acting together with it, are of course also to be employed in the case where the cylinder pair 01, 06 does not act together with a second transfer cylinder 07, but instead with a counter-pressure cylinder, for example embodied as a steel cylinder.

Here, a dressing 11 is understood to be a one-piece printing plate 11, for example. The dressing 09 for the transfer cylinder 02, 07 represents a one-piece blanket 09. This one-piece blanket 09 can be embodied in a single layer or multiple layers, wherein for the latter at least one layer 22, for example, has been applied on a support plate 21 and is fixedly connected therewith. The ends 23, 24 of the single- or multi-layer blanket 09 act together with a holding device 26 arranged in the groove 14, 16, 17, 18.

The embodiment of the blanket 09 as a multi-layer blanket 09 which, when the forme cylinder 03 rolls off on the transfer cylinder 02, for example, does not change its length or width at all, or only negligibly, by flexing, is particularly advantageous in connection with narrow openings of the grooves 14, 16, 17, 18 toward the shell surface of the transfer cylinder 02, 07. For this purpose the blanket unit 09 has, as shown in FIG. 8, the almost dimensionally fixed support plate 21, for example made of metal or plastic, on which the elastic, or soft layer 22 is applied (indicated in FIGS. 1 and 2). In the present example of the multi-layer blanket 09, the ends 23 and 24 of the blanket 09 are identical with the ends of the support plate 21, since in the area acting together with the groove 14, 16, 17, 18 the support plate 21 is bent off and without the layer.

In another embodiment the support plate 21 of the multi-layer blanket 09 can also be provided with a layer up to the ends of the support plate 21, wherein in this case the ends 23 and 24 of the multi-layer blanket 09 also have the layer 21, besides the support plate 21. If the blanket is embodied as a simple rubber blanket 09, the ends 23, 24 of the rubber blanket 09 act together with the grooves 14, 16, 17, 18.

In an advantageous embodiment, the grooves 12, 13 can also have holding devices 33 for the printing formes 11.

The holding device 26, 33 can be a known device for the frictionally connected or interlocked holding and/or bracing of a dressing 09, 11, such as, for example, frictionally connected or interlocking mechanisms, bracing strips or shafts driven by means of spring force or drive mechanisms, or tangential catches.

In FIG. 8, an advantageous embodiment of a holding device 26, 33 for a dressing 09, 11, in particular for a multi-layer blanket 09 or a printing forme 11, is shown representatively by the example of a multi-layer blanket 09 by means of the groove 14 in the transfer cylinder 11. The arrangement of such or similar holding devices 33 for the printing formes 11 in the grooves 12, 13 is indicated by way of example in FIG. 2.

For holding the blanket 09, the holding device 26 is arranged in the axially extending groove 14 of the transfer cylinder 02. The actuation of the device for bracing or holding the multi-part blanket 09 takes place by means of a shaft 27, for example a spindle 27 with pressure elements 28, rotatably seated in the groove 14 of the transfer cylinder 02.

The groove 14 extending parallel with the axis of the transfer cylinder 02 and inclined by 30 to 60°, in particular approximately 45°, in respect to the tangent line of the shell surface, has a gap 29 on the shell surface of the transfer cylinder 02 and a bore 31, which is located in the interior of the transfer cylinder 02 and connected with the gap 29. The width b29 of the gap 29 in the area of the shell surface in the circumferential direction of the transfer cylinder (02, 03, 07, 08) is greater than twice the thickness of one of the ends 23, 24 of the blanket 09 which, in the present example, is equal to twice the thickness of the support plate 21. Regarding the width b29 of the gap 29, 1 mm≧b29≧5 mm, in particular b29≧3 mm, applies in an advantageous manner. In the case of a simple rubber blanket 09, the width b09 is negligibly greater than twice the thickness of the rubber blanket 09, in the case of the multi-layer blanket 09 layered up to the ends of the support plate 21, the width b29 should be selected to be negligibly greater than twice the thickness of the layered end 23, 24 of the multi-layer blanket 09.

The shaft 27, for example a pivotable spindle 27, on which the pressure elements 28, for example plungers, spheres or the like are arranged resiliently and facing outward, is arranged in the bore 31.

For bracing the blanket 09, both ends 23, 24 of the blanket 09, in the example this is the equivalent of the ends of the support plate 21, are guided into the gap 29, and the spindle 27 with the pressure elements 28 is pivoted in such a way that it presses almost vertically against the leading and trailing ends 23 and 24 of the blanket 09, or of the support plate 21 and a wall 32 fixed on the cylinder, and maintains them in a frictionally connected manner in the gap 29. If several blankets 09 are arranged one behind the other in the circumferential direction of the transfer cylinder 02, respective leading and trailing ends 23 and 24 of adjoining blankets 09 act together. The holding device 26 can additionally have a pusher, not represented, which can be pushed into the gap 29 in addition to the ends 23 and 24 and closes the gap 29 off toward the exterior. This pusher is advantageously connected with the spindle 27, so that it is moved into, or out of, the gap 29 when the spindle 27 is pivoted. When employing such a pusher, the width b29 of the gap 29 is designed to be appropriately wider.

In a preferred embodiment, the grooves 12, 13 of the forme cylinders 03, 08 are also embodied, as in connection with the grooves 14, 16, 17, 18, as narrow gaps 12, 13, which are inclined by 30 to 60°, in particular by approximately 45°, in respect to the tangent line of the shell surface and have a width b12 (FIGS. 1, 2) in the area of the shell surface in the circumferential direction which is greater than twice the thickness of the printing forme 11. Regarding the width b12 of the gap 12, 1 mm≧b12≧5 mm, in particular b12≧3 mm, applies in an advantageous manner. For an exemplary basic representation of the holding device 33 for the printing forme 11 it is merely necessary in FIG. 8, which represents the multi-part blanket 09, to replace the multi-part blanket 09 (made of a support plate 21 and layer 22) by a printing forme 11 with bent-off ends extending into the groove 12, 13. The reference symbol for the width b29 would correspond to the width b12, and the reference symbol for the transfer cylinder 02 to that of the forme cylinder, for example 03. The ends 23, 24 would correspond to the bent-off ends of the printing forme 11.

It is possible to do without a holding device 33 in the grooves 12, 13 of the forme cylinders 03, 08 if secure seating is assured by means of the shaping of the ends of the printing forme 11 and/or the grooves 12, 13.

List of Reference Numerals

| | |
|---|---|
| 01 | Cylinder pair, first |
| 02 | Cylinder, transfer cylinder (01) |
| 03 | Cylinder, forme cylinder (01) |
| 04 | Material to be imprinted |
| 05 | — |
| 06 | Cylinder pair, second |
| 07 | Cylinder, transfer cylinder (06) |
| 08 | Cylinder, forme cylinder (06) |
| 09 | Dressing, blanket, rubber blanket |
| 10 | — |
| 11 | Dressing, printing forme, printing plate |
| 12 | Groove, gap (03, 08) |
| 13 | Groove, gap (03, 08) |
| 14 | Groove (02, 07) |
| 15 | — |
| 16 | Groove (02, 07) |
| 17 | Groove (02, 07) |
| 18 | Groove (02, 07) |
| 19 | — |
| 20 | — |
| 21 | Support plate (09) |
| 22 | Layer (09) |
| 23 | End (09) |
| 24 | End (09) |
| 25 | — |
| 26 | Holding device |
| 27 | Shaft, spindle |
| 28 | Pressure element |
| 29 | Gap |
| 30 | — |
| 31 | Bore (02, 03, 07, 08) |
| 32 | Wall (02, 03, 07, 08) |
| 33 | Holding device |
| b12 | Width (12, 13) |
| b19 | Width (19) |

1. A printing group of a rotary printing press, having at least one transfer cylinder (02, 07) and at least one forme cylinder (03, 08), wherein the transfer cylinder (02, 07) has a groove (14, 16, 17, 18) for receiving one or several blankets (09), and the forme cylinder (03, 08) has at least two grooves (12, 13), arranged one behind the other in the circumferential direction in at least one section arranged along the forme cylinder (03, 08), for receiving one or several printing formes (11) on the forme cylinder (03, 08), characterized in that at least one of the grooves (12, 13) of the forme cylinder (03, 08) is covered at least partially by a printing forme (11), and that the at least partially covered groove (12, 13) for receiving one or several printing formes (11) rolls off in the area of a groove (14, 16, 17, 18) for receiving one or several blankets (09) of the cooperating transfer cylinder (02, 07).

2. The printing group in accordance with claim 1, characterized in that at least one of the grooves (12, 13) extends over almost the entire length of a barrel of the forme cylinder (03, 08).

3. The printing group in accordance with claim 1, characterized in that the forme cylinder (03, 08) has two grooves (12, 13), which are offset by 180° in the circumferential direction and each extends over almost the entire length of the barrel of the forme cylinder (03, 08).

4. The printing group in accordance with claim 1, characterized in that the forme cylinder (03, 08) and the transfer cylinder (02, 07) have identical circumferences.

5. The printing group in accordance with claim 1, characterized in that the forme cylinder (03, 08) has at least two printing formes (11), which are arranged next to each other in the longitudinal direction of the forme cylinder (03, 08) and each extends over almost the entire circumference.

6. The printing group in accordance with claim 5, characterized in that the ends of the printing formes (11) are arranged in a groove (12, 13), or at least aligned along the forme cylinder (03, 08).

7. The printing group in accordance with claim 5, characterized in that the ends of the printing formes (11) are arranged offset from each other in the circumferential direction in different grooves (12, 13).

8. The printing group in accordance with claim 1, characterized in that the forme cylinder (03, 08) has a single printing forme (11).

9. The printing group in accordance with claim 1, characterized in that the forme cylinder (03, 08) has at least two printing formes (11) next to each other in the axial direction.

10. The printing group in accordance with claim 1, characterized in that the forme cylinder (03, 08) has several printing formes (11) arranged one behind the other in the circumferential direction.

11. The printing group in accordance with claim 1, characterized in that the printing formes (11) extend in the longitudinal direction over almost the entire length of the barrel of the forme cylinder (03, 08).

12. The printing group in accordance with claim 1, characterized in that the forme cylinder (03, 08) has three printing formes (11), arranged next to each other in the longitudinal direction of the forme cylinder (03, 08) and each over the entire circumference, whose ends are arranged alternatingly offset in respect to each other in the circumferential direction.

13. The printing group in accordance with claim 1, characterized in that the barrel of the forme cylinder (03, 08) has a circumference corresponding to at least two horizontal or vertical newspaper pages.

14. The printing group in accordance with claim 1, characterized in that a barrel of the forme cylinder (03, 08) has a width approximately corresponding to four horizontal or vertical newspaper pages.

15. The printing group in accordance with claim 1, characterized in that a barrel of the forme cylinder (03, 08) has a width approximately corresponding to eight vertical book pages.

16. The printing group in accordance with claim 1, characterized in that the barrel of the forme cylinder (03, 08) has a circumference corresponding to approximately six horizontal or vertical newspaper pages.

17. The printing group in accordance with claim 1, characterized in that in the area of the shell surface, the groove (12, 13) of the forme cylinder (03, 08) has a width (b12) in the circumferential direction which is greater than twice the thickness of the printing forme (11) and lies in the range between 1 mm and 5 mm, in particular less than or equal to 3 mm.

18. The printing group in accordance with claim 1, characterized in that the ratio of the circumference of the transfer cylinder (02, 07) to that of the forme cylinder (03, 08) is a whole number.

19. The printing group in accordance with claim 1, characterized in that the transfer cylinder (02, 07) has two grooves (14, 16, 17, 18) arranged one behind the other in the circumferential direction.

20. The printing group in accordance with claim 1, characterized in that the transfer cylinder (02, 07) has two grooves next to each other in the axial direction and that the grooves (14, 16, 17, 18) are arranged one behind the other in the circumferential direction.

21. The printing group in accordance with one of claims 1, 19 or 20, characterized in that the grooves (14, 16, 17, 18) are arranged with even spacing in the circumferential direction.

22. The printing group in accordance with claim 21, characterized in that two grooves (12, 13, 14, 16, 17, 18) are arranged offset by approximately 180° in the circumferential direction.

23. The printing group in accordance with one of claims 19 or 20, characterized in that at least two blankets (09) are arranged in the longitudinal direction on the transfer cylinder (02, 07) which acts together with the forme cylinder (03, 08), which extend over almost the entire circumference and respectively cover a portion of the grooves (14, 16, 17, 18).

24. The printing group in accordance with claim 22, characterized in that the groove(s) (14, 16, 17, 18) in the transfer cylinder (02, 07), which are covered by the blanket(s) (09), in the course of the rolling off of the transfer cylinder (02, 07) on the forme cylinder (03, 08) act together with a groove (12, 13) of the forme cylinder (03, 08).

25. The printing group in accordance with claim 1, characterized in that the groove (12, 13, 14, 16, 17, 18) has at least one holding device (26, 33).
